(19) United States
(12) Patent Application Publication
(10) Pub. No.: US 2021/0279609 A1
(43) Pub. Date: Sep. 9, 2021

(54) FAILURE PREDICTION APPARATUS AND LEARNING DEVICE

(71) Applicant: FUJIFILM Business Innovation Corp., Tokyo (JP)

(72) Inventor: Fumitaka KIKAWADA, Kanagawa (JP)

(73) Assignee: FUJIFILM Business Innovation Corp., Tokyo (JP)

(21) Appl. No.: 17/030,353

(22) Filed: Sep. 23, 2020

(30) Foreign Application Priority Data
Mar. 3, 2020 (JP) 2020-035757

(51) Int. Cl. G06N 5/04; G06N 20/00

(52) U.S. Cl. CPC G06N 5/04; G06N 20/00

(57) ABSTRACT

A failure prediction apparatus includes an acquisition unit that acquires external reaction information and a processor. The processor is configured to, by running a program, input external reaction information acquired by the acquisition unit to a learning model that is learned by performing machine learning for presuming a relationship between information regarding an in-house failure that had occurred in the past due to a failure occurred in the past in another company and external reaction information generated due to the failure, execute arithmetic processing using the learning model, and output prediction information regarding occurrence of an in-house failure from the learning model.

### CROSS-REFERENCE TO RELATED APPLICATIONS

This application is based on and claims priority under 35 USC 119 from Japanese Patent Application No. 2020-035757 filed Mar. 3, 2020.

### BACKGROUND

### (i) Technical Field

The present disclosure relates to a failure prediction apparatus and a learning device.

### (ii) Related Art

Proactive measures (preliminary measures) may be taken against a failure by performing machine learning on the past in-house information including a server log, an access log, and a server resource status and predicting the failure in advance.

Japanese Unexamined Patent Application Publication No. 2013-145426 describes a technology for predicting an unknown failure by performing machine learning on in-house data. In other words, Japanese Unexamined Patent Application Publication No. 2013-145426 describes a technology for storing in advance a content of a failure and a determination condition for suspension into a central server, determining whether suspension is necessary from failure information related to another financial institution when the central server is informed of this information from an automated teller machine (ATM), and suspending the ATM's collaboration service with other banks.

In the case of using only in-house data, or with a configuration in which the influence of a failure occurred in another company is detected, sufficient measures are not always taken in application programming interface (API) integration of the related art, that is, in a situation in which an API enables interaction between the existing services or data items. When a company provides a service by using a service provided by another company, it is impossible to predict a failure that may occur in the company's own service by using only in-house data. In addition, in the case where the company takes measures against an in-house failure after actually receiving and checking information regarding a failure occurred in the other company, the measures taken by the company are always reactive measures.

### SUMMARY

Aspects of non-limiting embodiments of the present disclosure relate to providing a technology for enabling, by using external reaction information other than in-house information, prediction of an in-house failure that may occur due to occurrence of a failure in another company.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a failure prediction apparatus including an acquisition unit that acquires external reaction information and a processor. The processor is configured to, by running a program, input external reaction information acquired by the acquisition unit to a learning model that is learned by performing machine learning for presuming a relationship between information regarding an in-house failure that had occurred in the past due to a failure occurred in the past in another company and external reaction information generated due to the failure, execute arithmetic processing using the learning model, and output prediction information regarding occurrence of an in-house failure from the learning model.

### BRIEF DESCRIPTION OF THE DRAWINGS

Exemplary embodiments of the present disclosure will be described in detail based on the following figures, wherein:

FIG. 1 is a diagram illustrating a configuration of a failure prediction apparatus in an exemplary embodiment;

FIG. 2 is a diagram illustrating reaction data in the exemplary embodiment;

FIG. 3 is a diagram illustrating outside failure data and in-house failure data in the exemplary embodiment;

FIG. 4 is a diagram illustrating teaching data in the exemplary embodiment;

FIG. 5 is a diagram illustrating a configuration of a learning processing unit of the failure prediction apparatus in the exemplary embodiment;

FIG. 6 is a diagram illustrating a configuration of a failure prediction unit of the failure prediction apparatus in the exemplary embodiment;

FIG. 7 is a processing flowchart in the exemplary embodiment;

FIG. 8 is a diagram illustrating teaching data in a first modification;

FIG. 9 is a diagram illustrating teaching data in a second modification; and

FIG. 10 is a diagram illustrating an output screen in the second modification.

### DETAILED DESCRIPTION

An exemplary embodiment of the present disclosure will be described below with reference to the drawings.

### <Basic Principle>

A basic principle of the exemplary embodiment will be described first.

In the case where a company provides a service by using a service provided by another company through API integration, when some type of failure occurs in a system or a server of the other company, the company may be affected by the failure, and a failure may occur in a system or a server that provides the service of the company. In this case, during the period from the occurrence of the failure in the system or the server of the other company until the occurrence of the failure in the system or the server that provides the service of the company, information (hereinafter referred to as “reaction information”) is generated due to the occurrence of the failure in the system or the server of the other company on an external website excluding the company's own website, a social networking service (SNS), and the like. Examples of such reaction information are as follows: a tweet “It seems that the OO service is currently unavailable.” posted on an SNS by a third party who uses the system of the other company, a tweet “I heard that a failure has occurred in the OO service.” posted by another third party, and an announcement “Our service is currently suspended due to suspension of the OO service” posted on a website by another third party. After such external reaction information has been generated, the system or the server that provides the service of the company is eventually affected by the failure occurred in the system or the server of the other company, and a failure occurs in the system or the server of the company.

Accordingly, information regarding a failure that had occurred in the past in the other company, information regarding a failure occurred in the company due to the failure, and external reaction information generated due to the failure are collected as a set of data items, and machine learning is performed by using the set of these data items as teaching data so as to learn the correlation between the external reaction information and the information regarding the in-house failure. Here, the term “machine learning” refers to an algorithm that is used by a computer system in order to effectively perform a specific task by relying on a pattern and an inference instead of using an explicitly instruction. The machine learning algorithm constructs a mathematical model on the basis of sample data known as “training data” or “teaching data”. The machine learning in the present exemplary embodiment is a supervised learning that generates a function that maps an input and a corresponding output. More specifically, in the present exemplary embodiment, information regarding an in-house failure that had occurred due to occurrence of a in another company and external reaction information generated due to the in-house failure are paired with each other and used as teaching data so as to learn the correlation between the trend in reaction information and occurrence or nonoccurrence of an in-house failure. When a function that defines the correlation is denoted by f, the following equation is satisfied.
occurrence or nonoccurrence of in-house failure=f (external reaction information)

The “occurrence or nonoccurrence of in-house failure” may include the probability of occurrence of an in-house failure. In other words, the following equation is satisfied.
probability of occurrence of in-house failure=f (external reaction information)

The function f corresponds to a learned mathematical model.

After obtaining the correlation between external reaction information and occurrence of an in-house failure through the learning, that is, after generating a learned model that uses external reaction information and occurrence or nonoccurrence of an in-house failure as an input and an output, respectively, external reaction information that is currently generate is acquired and input to the learned model, so that occurrence or nonoccurrence of an in-house failure is predicted from the external reaction data information.

In a qualitative perspective, in the case where a failure had occurred in the past in another company, external reaction information generated due to the failure shows a certain trend, and an in-house failure has actually occurred, when the current external reaction information shows a trend similar to the certain trend, the learned model outputs information indicating occurrence of an in-house failure. When the current external reaction information shows a trend that is not similar to the certain trend, the learned model outputs information indicating nonoccurrence of an in-house failure.

In the present exemplary embodiment, it should be noted that, after a learned model has been generated, it is only necessary to input the current external reaction information, and input of information regarding a failure that had actually occurred in another company is not necessary.

In the present exemplary embodiment, although it is necessary to determine external reaction information, particularly the trend of external reaction information, the trend of external reaction information may be determined as time-series variations in the amount of data and may be determined by using, for example, the following parameters.
the date and time when generation of reaction information is started
the period from when generation of reaction information is started until the amount of reaction information becomes maximum
the maximum value of the amount of reaction information
the period from when generation of reaction information is started until reaction information decreases to a certain amount or less

In the present exemplary embodiment, a commonly known machine learning may be used as machine learning of the correlation between external reaction information and occurrence of an in-house failure. Examples of such a commonly known machine learning include a neural network (NN), a convolutional neural network (CNN), a support vector machine (SVM), and a Bayesian network may be used. Alternatively, deep learning using a multilayer neural network may be used.

In the case where the learned model outputs occurrence or nonoccurrence of an in-house failure, the output of the learned model is a binary output of either “in-house failure will occur” or “in-house failure will not occur”. In the case where the learned model outputs the probability of occurrence of an in-house failure, the output of the learned model is a multivalued output within a range of 0% to 100%.

The present exemplary embodiment will be described in detail below by taking a CNN as an example of machine learning.

### <Configuration>

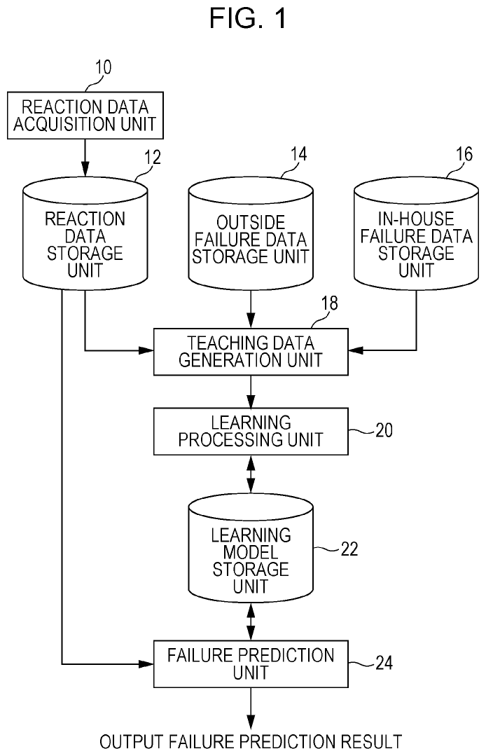

FIG. 1 is a block diagram illustrating the configuration of a failure prediction apparatus in the exemplary embodiment. The failure prediction apparatus includes a reaction data acquisition unit 10, a reaction data storage unit 12, an outside failure data storage unit 14, an in-house failure data storage unit 16, a teaching data generation unit 18, a learning processing unit 20, a learning model storage unit 22, and a failure prediction unit 24.

The reaction data acquisition unit 10 acquires reviews and tweets that are posted on the external media and SNSs excluding the media of the company, to which the reaction data acquisition unit 10 belongs, failure information posted on external websites, and the like as reaction information through, for example, the Internet and stores them in the reaction data storage unit 12. More specifically, the reaction data acquisition unit 10 is formed of a software robot and automatically acquires data from websites and the like on the Internet. A tool that is called “crawler” for collecting data from an infinite number of websites on the Internet may be used. A crawler is a program that enables a robot-type search engine to collect files in general (including HTML documents, images, and PDF files) on websites. It is obvious that a user may manually acquire such files by using a computer.

The reaction data storage unit 12 stores reaction data items that are acquired by the reaction data acquisition unit 10. Reaction data items are sequentially stored on a time-series basis. A specific example is as follows.
time t1: reaction data item a
time t2: reaction data items b1 and b2
time t3: reaction data items c1, c2, and c3

Although the times t1 to t3 each refer to the transmission time of the corresponding reaction data item, in the case where the transmission time is unknown, each of the times t1 to t3 may be the acquisition time of the corresponding reaction data item. Along with each reaction data item, the type of the reaction data item (i.e., a review or a tweet on an SNS, an information item on a website, or the like) may be stored. In addition, if a transmission source of the reaction data item is identified, the transmission source may be stored. Reaction data items include the past reaction data items and the current reaction data items. The past reaction data items are each associated with data regarding an outside failure, which is a failure occurred in another company. The past reaction data items may each include an ID that identifies the corresponding outside failure and that had become a cause of generation of the corresponding reaction.

The outside failure data storage unit 14 stores data regarding a failure occurred in a system or a server that provides a service of another company. Outside failure data is data regarding a failure occurred in another company (failure data obtained by receiving and checking, for example, an announcement of occurrence of a failure made by another company), the data being detected in-house, and includes the name of the other company, the name of the service provided by the other company, the function name of the service, and the date and time of the occurrence of the failure.

The in-house failure data storage unit 16 stores data regarding a failure occurred in a system or a server of the company, to which the in-house failure data storage unit 16 belongs, in the case where the company provides a service by using a service provided by another company through API integration.

In other words, the in-house failure data storage unit 16 stores data regarding an in-house failure that had occurred due to occurrence of an outside failure, which is a failure occurred in another company. The in-house failure data includes the name of an in-house function in which a failure had occurred and the date and time of the occurrence of the in-house failure. In-house failure data may include an ID that identifies an outside failure, which is a cause of an in-house failure.

The teaching data generation unit 18 reads the past reaction data stored in the reaction data storage unit 12, the past outside failure data stored in the outside failure data storage unit 14, and in-house failure data stored in the in-house failure data storage unit 16 and combines these data items to generate teaching data. The teaching data generation unit 18 may combine these data items by using, as a key, an ID that identifies an outside failure. Teaching data is formed of a set of reaction data, outside failure data, and in-house failure data. The teaching data generation unit 18 supplies teaching data generated thereby to the learning processing unit 20.

The learning processing unit 20 performs machine learning by using generated teaching data and generates a mathematical model that defines the correlation between reaction data and occurrence of an in-house failure, that is, a mathematical model using reaction data and occurrence or nonoccurrence of an in-house failure (including the probability of occurrence of an in-house failure) as an input and an output, respectively, and stores the mathematical model in the learning model storage unit 22 as a learned model.

The failure prediction unit 24 uses a learned model stored in the learning model storage unit 22 and inputs the current reaction data stored in the reaction data storage unit 12 to the learned model. Then, the failure prediction unit 24 outputs occurrence or nonoccurrence of an in-house failure as a prediction result. The learning processing unit 20 and the failure prediction unit 24 will be further described later.

Although the case in which the failure prediction apparatus includes the learning processing unit 20 and the failure prediction unit 24 is illustrated in FIG. 1, the failure prediction apparatus may not include the learning processing unit 20 and may include the failure prediction unit 24, and the failure prediction apparatus may acquire a learned model obtained by learning with an external apparatus via a communication line or the like. The failure prediction unit 24 may use a learned model acquired by the failure prediction apparatus and may input the current reaction data stored in the reaction data storage unit 12 to the learned model. Then, the failure prediction unit 24 may output occurrence or nonoccurrence of an in-house failure as a prediction result.

In other words, the failure prediction apparatus may have both a function of learning the correlation between reaction data and occurrence or nonoccurrence of an in-house failure and a function of predicting occurrence or nonoccurrence of an in-house failure from the current reaction data by using a learned model, which is obtained through learning. Alternatively, the failure prediction apparatus may have only a function of predicting occurrence or nonoccurrence of an in-house failure from the current reaction data by using a learned model, which is obtained through learning. An apparatus that has a function of learning the correlation between reaction data and occurrence or nonoccurrence of an in-house failure may be fabricated as a learning apparatus separately from the failure prediction apparatus.

The failure prediction apparatus illustrated in FIG. 1 may be formed of a computer that includes a processor and a memory. The processor performs processing by reading and running a program stored in the memory. The term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device). In addition, the term “processor” is broad enough to encompass one processor or plural processors in collaboration which are located physically apart from each other but may work cooperatively.

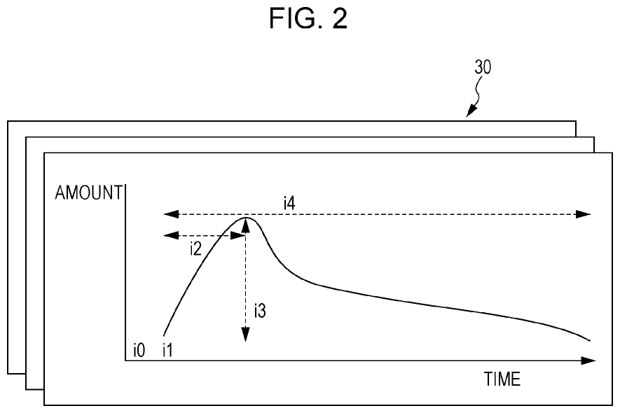

FIG. 2 illustrates an example of reaction data items 30 stored in the reaction data storage unit 12. The reaction data items 30 are acquired and stored as time-series data items. The reaction data storage unit 12 tabulates these data items on a time-series basis. In FIG. 2, each of the reaction data items 30 is represented by a graph in which the horizontal axis and the vertical axis respectively denote time and data amount.

When the reaction data items 30, each of which is generated due to a failure occurred in another company, are each considered as a function of time, the trend of each of the reaction data items 30 may be determined by five parameters which are listed below.

i0: the date and time of occurrence of a failure
i1: the time at which generation of reaction data 30 is started
i2: the period from when generation of reaction data 30 is started until the amount of reaction data becomes maximum
i3: the maximum value of the amount of reaction data
i4: the period from when generation of reaction data 30 is started until reaction data decreases to a certain amount or less

The amount of change in data per predetermined period of time may be used other than the above parameters. The reaction data storage unit 12 stores these reaction data items 30 as the past reaction data items 30 each time a failure occurs in another company. The plurality of reaction data items illustrated in FIG. 2 are reaction data items for each occurrence of a failure in another company. In addition, regardless of occurrence or nonoccurrence of a failure in another company, the reaction data storage unit 12 successively acquires the current reaction data items 30 and stores these data items as the current reaction data items 30. Each of the current reaction data items 30 is also represented as a change in the amount of data over time.

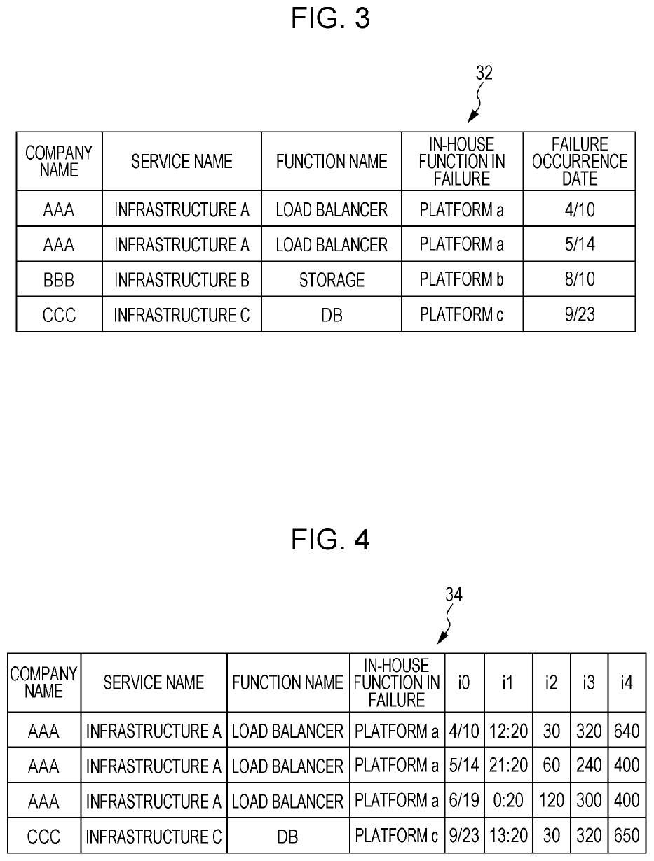

FIG. 3 illustrates data 32 that is obtained by integrating outside failure data stored in the outside failure data storage unit 14 and in-house failure data stored in the in-house failure data storage unit 16. The name of another company, the name of a service provided by the other company, the name of a function of the service, an in-house function in which a failure occurs, and the date of the occurrence of the in-house failure are associated with one another. A specific example of the data 32 is as follows.
company name: AAA
service name: infrastructure A
function name: load balancer
in-house function in failure: platform a
failure occurrence date: 4/10

The above example indicates that a failure occurs in an in-house platform a on April 10th due to a failure occurred in a load balancer (load adjustment) function of a service called “infrastructure A” that is provided by AAA company.

The name of another company, the name of a service, and the name of a function are stored in the outside failure data storage unit 14, and an in-house function in which a failure occurs, and the date of occurrence of an in-house failure are stored in the in-house failure data storage unit 16. The outside failure data storage unit 14 and the in-house failure data storage unit 16 may be integrated into a single storage unit and may store the data 32 illustrated in FIG. 3.

FIG. 4 illustrates an example of teaching data 34 that is generated by the teaching data generation unit 18. The teaching data generation unit 18 generates a set of teaching data by combining the reaction data 30 and the data 32. A set of teaching data includes the name of another company, the name of a service, the name of a function, an in-house function in which a failure occurs, and reaction data. The above-mentioned five parameters (i0, i1, i2, i3, and i4) represent the trend of the reaction data 30. A specific example of the teaching data 34 is as follows.
company name: AAA
service name: infrastructure A
function name: load balancer
in-house function in failure: platform a
i0: 4/10
i1: 12:20
i2: 30 minutes
i3: amount of data is 320
i4: 640 minutes

The above example indicates the following: a failure occurs in an in-house platform a on April 10th due to a failure occurred in a load balancer (load adjustment) function of a service called “infrastructure A” that is provided by AAA company, generation of reaction data is started at 12:20 on April 10th due to the occurrence of the failure, reaction data is increased to 320, which is the maximum amount, 30 minutes after the start of generation of reaction data, and it takes 640 minutes for the reaction data to decrease to a certain amount or less.

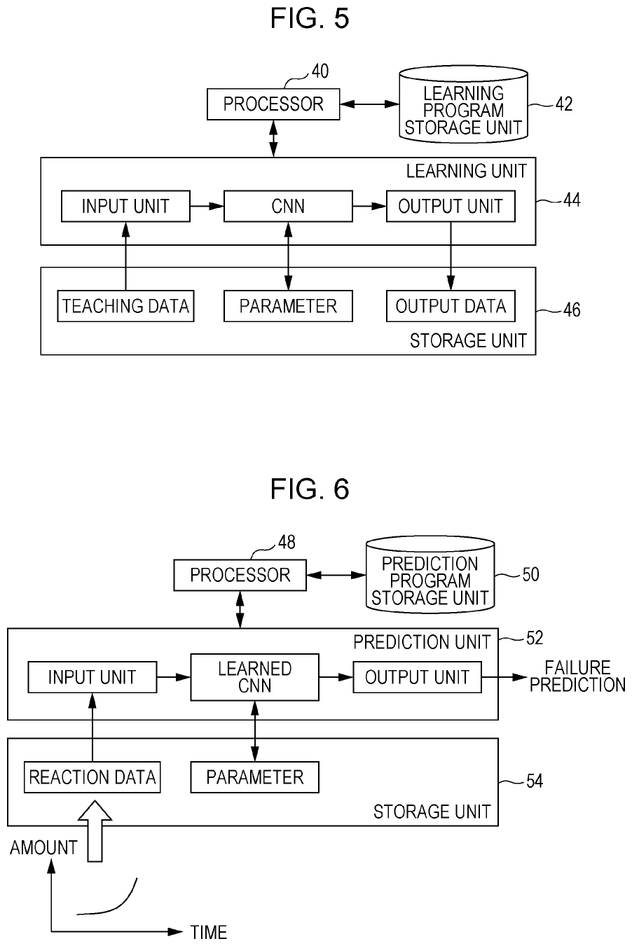

FIG. 5 illustrates a functional block diagram of the learning processing unit 20. The learning processing unit 20 includes a processor 40, a learning program storage unit 42, a learning unit 44, and a storage unit 46. The processor 40 causes the learning unit 44 to operate by reading and running a learning program stored in the learning program storage unit 42.

The learning unit 44 includes, for example, a CNN, and the CNN is formed by using memory on the basis of a CNN library, definition data, and parameter information that are stored in the storage unit 46. The learning unit 44 includes an input unit that inputs teaching data to the CNN and an output unit that outputs calculation results from the CNN. Teaching data that is supplied to the input unit is the teaching data 34 illustrated in FIG. 4 and is stored in the storage unit 46. An output result from the CNN is occurrence or nonoccurrence of an in-house failure and is stored in the storage unit 46 as output data. The CNN includes a plurality of convolutional layers, a plurality of pooling layers, and a plurality of fully connected layers that are defined by the definition data.

The processor 40 performs processing for minimizing the error between the output data that is obtained by inputting teaching data to the CNN and the output of known teaching data in accordance with the learning program and adjusts the parameter information including a weight coefficient of each layer. More specifically, the processor 40 performs learning by using the reaction data items (i0 to i4) included in the teaching data 34 as an input and a data item regarding an in-house function in which a failure occurs, the data item being included in the teaching data 34, as an output and adjusts the weight coefficient of each of the layers of the CNN. Subsequently, the processor 40 inputs reaction data (the trend of reaction data) and then learns the CNN so as to output occurrence or nonoccurrence of an in-house failure. After inputting reaction data (the trend of reaction data), the processor 40 may learn the CNN so as to output the probability of occurrence of an in-house failure. Alternatively, after inputting reaction data (the tendency of reaction data), the processor 40 may learn the CNN so as to output occurrence or nonoccurrence of an in-house failure and information regarding an in-house function in which a failure occurs.

The parameter information including the weight coefficients of the layers, which have been adjusted through the learning, is stored in the storage unit 46 as learned parameter information.

FIG. 6 illustrates a functional block diagram of the failure prediction unit 24. The failure prediction unit 24 includes a processor 48, a prediction program storage unit 50, a prediction unit 52, and a storage unit 54.

The processor 48 causes the prediction unit 52 to operate by reading and running a prediction program that is stored in the prediction program storage unit 50.

In the prediction unit 52, a learned CNN learned by the learning processing unit 20 illustrated in FIG. 5, specifically, definition information that defines the CNN and adjusted parameter information stored in the storage unit 54 are used, such that an input unit inputs the current reaction data (the trend of reaction data) to the learned CNN and that an output unit outputs prediction of occurrence or nonoccurrence of an in-house failure. The output unit may output the probability of occurrence of an in-house failure or may output information regarding an in-house function in which a failure occurs. As illustrated in FIG. 6, the current reaction data is specified as the amount of reaction data in time series, and an example thereof is as follows.
i1: 12/21
i2: 20 minutes
i3: amount of data is 300

Note that the current reaction data does not include the parameter i0 because it is unknown whether a failure occurs in another company. The current reaction data also does not include the parameters i2 and i3 when the amount of the current reaction data has not yet reached its peak. In this case, at least the parameter i1 and the amount of data in the subsequent predetermined detection cycle are specified as the trend of reaction data.

The adjusted parameter information stored in the storage unit 54 is the same as the adjusted parameter information stored in the storage unit 46. In the case where the learning processing unit 20 and the failure prediction unit 24 are included in the same failure prediction apparatus, the processor 40 and the processor 48 may be the same as each other, and the storage unit 46 and the storage unit 54 may be the same as each other. In addition, the storage unit 46 and the storage unit 54 function as the learning model storage unit 22. In the case where the failure prediction apparatus does not include the learning processing unit 20, the adjusted parameter information stored in the storage unit 46 is transmitted from the storage unit 46 to the storage unit 54 via, for example, a communication line and stored in the storage unit 54. In other words, the learned CNN obtained as a result of the learning processing unit 20 performing learning is transmitted to the failure prediction unit 24 via a communication line.

When the current reaction data is input to the learned CNN, the learned CNN outputs, for example, prediction of occurrence or nonoccurrence of an in-house failure. More specifically, when the current reaction data is input to the learned CNN, the learned CNN outputs, for example, one of the following messages.

“An in-house failure will occur.”

“Occurrence of a failure in the in-house platform a was predicted.”

“The probability of occurrence of a failure in the in-house platform a is 70%.”

Occurrence or nonoccurrence of an in-house failure, the probability of occurrence of an in-house failure, and an in-house function in which a failure occurs may be suitably combined and output.

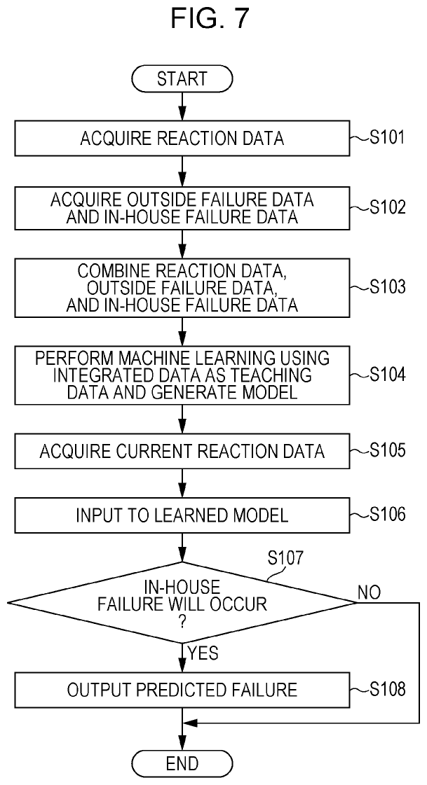

FIG. 7 is a processing flowchart in the present exemplary embodiment. The processing flowchart may be broadly divided into learning processing steps and failure prediction processing steps.

Steps S101 to S104 are the learning processing steps.

First, reaction data is acquired by the reaction data acquisition unit 10 (S101). Here, the reaction data includes the past reaction data. The acquired past reaction data is stored in the reaction data storage unit 12.

In parallel with the process of S101, outside failure data and in-house failure data are acquired (S102). The acquired outside failure data is stored in the outside failure data storage unit 14, and the acquired in-house failure data is stored in the in-house failure data storage unit 16. The outside failure data may be acquired from, for example, an announcement published on a website of another company, in which the corresponding failure had occurred, or news posted by a news organization. The in-house failure data is data regarding an in-house failure that had occurred due to occurrence of the failure in the other company.

Next, the teaching data generation unit 18 generates teaching data by combining the acquired past reaction data, the past outside failure data, and the past in-house failure data (S103). An example of the teaching data is illustrated in FIG. 4, and it may be said that these data items are parameters that determine the content of an outside failure, which is a failure occurred in another company, the content of an in-house failure occurred due to the outside failure, and the corresponding reaction data.

Note that, in the case where a company provides a service by using a service provided by another company through API integration, it is possible that a failure will occur in the company without being caused by a failure occurred in the other company. In-house failure data in such a case, that is, in-house failure data that is obviously irrelevant to any outside failure may be removed at the time of combining data items so as to be excluded from teaching data, so that the learning accuracy may be improved.

After teaching data has been generated, the learning processing unit 20 performs machine learning using the teaching data and generates a model that defines the correlation between reaction data and occurrence or nonoccurrence of an in-house failure or the probability of occurrence of an in-house failure (S104). The learned model is stored in the learning model storage unit 22.

Steps S105 to S108 are the failure prediction processing steps using the learned model.

First, the reaction data acquisition unit 10 acquires the current reaction data (S105).

Next, the failure prediction unit 24 inputs the current reaction data to the learned model and executes arithmetic processing so as to output, for example, occurrence or nonoccurrence of an in-house failure from the learned model (S106). The failure prediction unit 24 determines whether the output of the learned model indicates that an in-house failure will occur (S107). Note that, in the case where the output of the learned model is occurrence or nonoccurrence of an in-house failure, the output result is used as is as the result of determination as to whether an in-house failure will occur. In the case where the output of the learned model is the probability of occurrence of an in-house failure, when the probability is equal to or higher than a predetermined threshold (e.g., 60%), it is determined that an in-house failure will occur.

When it is determined that an in-house failure will occur (YES in S107), the failure prediction unit 24 outputs the prediction of occurrence of an in-house failure to a relevant department (S108). More specifically, the failure prediction unit 24 outputs, by email or the like, the following message to a management and operation department in charge of the system or the server related to a service in which the predicted in-house failure may occur.

“Occurrence of an in-house failure was predicted. Please beware.”

Here, when it is determined that an in-house failure will occur, this also implies that occurrence of a failure in another company that is an API integration partner is predicted. In other words, although the current reaction data is generated due to occurrence of a failure in another company, at the point in time when the fact that the failure has occurred in the service of the other company has not yet actually been recognized in-house, there is no choice but to predict (guess) the occurrence of the outside failure, and in this sense, it may be said that the determination result predicts the occurrence of the failure in the service of the other company, which is an API integration partner.

Thus, instead of a message “Occurrence of an in-house failure was predicted.”, for example, a message “Occurrence of an outside failure was predicted. In-house failure may occur accordingly.” may be output. The relevant department may take a necessary action in advance on the basis of the output prediction of occurrence of a failure.

### <First Modification>

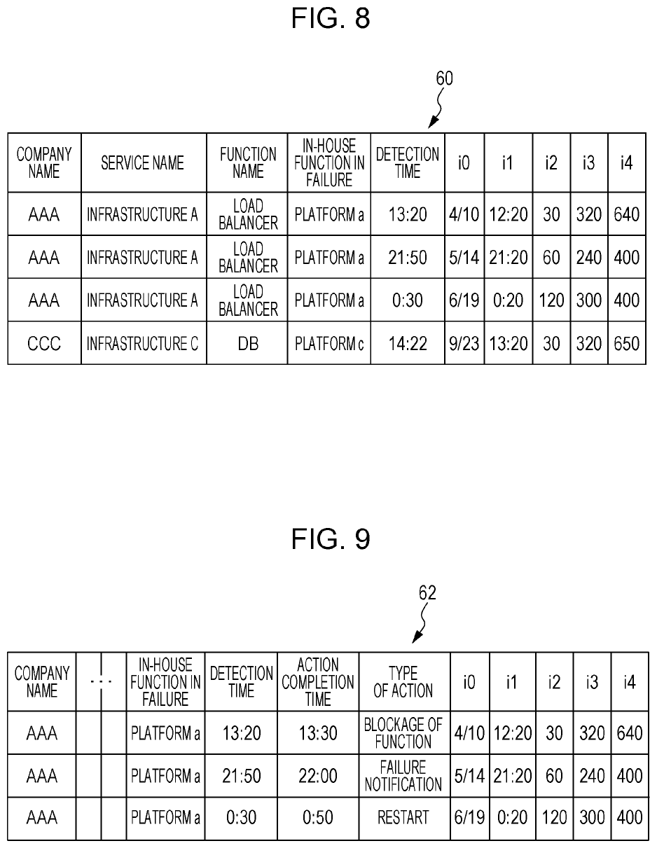

In the present exemplary embodiment, although machine learning is performed by using the teaching data illustrated in FIG. 4, machine learning may be performed by using teaching data 60 such as that illustrated in FIG. 8.

In FIG. 8, the teaching data 60 includes the detection time of occurrence of an in-house failure in addition to the teaching data 34 illustrated in FIG. 4. A specific example of the teaching data 60 is as follows.
company name: AAA
service name: infrastructure A
function name: load balancer
in-house function in failure: platform a detection time: 13:20
i0: 4/10
i1: 12:20
i2: 30 minutes
i3: amount of data is 320
i4: 640 minutes

The above example indicates the following: a failure occurs in an in-house platform a on April 10th due to a failure occurred in a load balancer (load adjustment) function of a service called “infrastructure A” that is provided by AAA company, generation of reaction data is started at 12:20 on April 10th due to the occurrence of the failure, reaction data is increased to 320, which is the maximum amount, 30 minutes after the start of generation of reaction data, it takes 640 minutes for the reaction data to decrease to a certain amount or less, and the detection time of the occurrence of the in-house failure is 13:20.

The learning processing unit 20 generates a model by performing machine learning using the teaching data 60 illustrated in FIG. 8. The learning processing unit 20 performs machine learning by using the teaching data 60 and generates a model in order to correlate the reaction data and the occurrence of the in-house failure with each other. When the current reaction data is input to the learned model, the learned model outputs occurrence, nonoccurrence, or the like of an in-house failure and the estimated time of occurrence of a failure. The estimated time of occurrence of a failure refers to the time at which it is estimated that occurrence of an in-house failure will be detected in-house. More specifically, the learned model outputs, for example, the following message.

“Occurrence of a failure in the in-house platform a was predicted. Estimated time of occurrence of failure: 12:21”.

The failure prediction unit 24 outputs the output result to the relevant department. In this case, the relevant department may take an action by taking the estimated time of occurrence of an in-house failure into consideration.

### <Second Modification>

In the exemplary embodiment, each in-house failure data may include the type of action taken against an in-house failure and the action completion time, and machine learning may be performed by using the teaching data 62 illustrated in FIG. 9.

In FIG. 9, the teaching data 62 includes the type of action taken against an in-house failure and the action completion time in addition to the teaching data 60 illustrated in FIG. 8. A specific example of the teaching data 62 is as follows.
company name: AAA
service name: infrastructure A
function name: load balancer
in-house function in failure: platform a detection time: 13:20
action completion time: 13:20
type of action: blockage of function
i0: 4/10
i1: 12:20
i2: 30 minutes
i3: amount of data is 320
i4: 640 minutes

The above example indicates the following: a failure occurs in an in-house platform a on April 10th due to a failure occurred in a load balancer (load adjustment) function of a service called “infrastructure A” that is provided by AAA company, generation of reaction data is started at 12:20 on April 10th due to the occurrence of the failure, reaction data is increased to 320, which is the maximum amount, 30 minutes after the start of generation of reaction data, it takes 640 minutes for the reaction data to decrease to a certain amount or less, the detection time of the occurrence of the in-house failure is 13:20, and the failure recovery is accomplished at 13:20 by taking an action, which is blockage of function.

The learning processing unit 20 generates a model by performing machine learning using the teaching data 62 illustrated in FIG. 9. The learning processing unit 20 performs machine learning by using the teaching data 60 and generates a model. When the current reaction data is input to the learned model, the learned model outputs occurrence, nonoccurrence, or the like of an in-house failure, the estimated time of occurrence of a failure, and the type of action to be taken against the failure.

Regarding the type of action to be taken, all possible actions may be output, or an action that may be taken and completed by the estimated time of occurrence of a failure may be output by comparing the estimated time of occurrence of a failure and the action completion time of each possible action.

More specifically, in the case where the current time is 12:15 and where the estimated time of occurrence of a failure is 12:21, when an action that may be immediately taken and may be completed by 12:21 among the possible actions that may be taken against the predicted failure is blockage of function, an example of the output is as follows.

“Occurrence of a failure in the in-house platform a was predicted.”

Estimated time of occurrence of failure: 12:21

Type of action: blockage of function

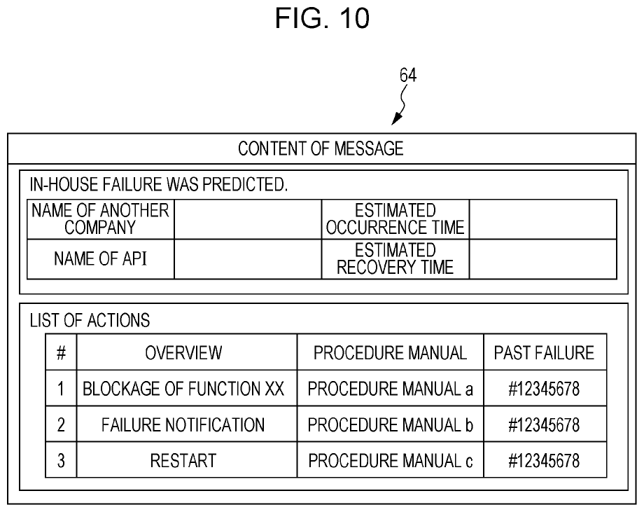

FIG. 10 illustrates an example of an output screen 64 of the failure prediction unit 24.

Along with a message “Occurrence of an in-house failure was predicted.”, the name of another company that may be a cause of the predicted in-house failure, the name of API, the estimated time of occurrence of the in-house failure, and the estimated recovery time are displayed. In addition, a list of actions that may be taken and completed by the estimated time of occurrence of the in-house failure is displayed. In the case where there are a plurality of possible actions, the actions are listed in a predetermined order, which is, for example, the order of action completion time, starting with the earliest.

Instead of the message “Occurrence of an in-house failure was predicted.”, a message “Occurrence of an outside failure was predicted.” may be displayed.

### <Third Modification>

In the present exemplary embodiment, although occurrence or nonoccurrence of a failure in a company due to occurrence of a failure in another company in the case where the company provides a service by using a service provided by the other company through API integration is predicted, the technology of the present exemplary embodiment is applicable to other fields.

For example, the technology of the present exemplary embodiment is applicable to the case of learning the past data regarding an epidemic situation of an infectious disease as teaching data and predicting occurrence or nonoccurrence of infection in an area where a person lives or estimating the probability of infection in the area from the current infection data.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A failure prediction apparatus comprising:
an acquisition unit that acquires external reaction information; and
a processor,
wherein the processor is configured to, by running a program,
input external reaction information acquired by the acquisition unit to a learning model that is learned by performing machine learning for presuming a relationship between information regarding an in-house failure that had occurred in the past due to a failure occurred in the past in another company and external reaction information generated due to the failure,
execute arithmetic processing using the learning model, and
output prediction information regarding occurrence of an in-house failure from the learning model.

2. The failure prediction apparatus according to claim 1,
wherein the processor is configured to output, as the prediction information, occurrence or nonoccurrence of an in-house failure and an estimated time of occurrence of a failure.

3. The failure prediction apparatus according to claim 2,
wherein the processor is further configured to output, as the prediction information, a type of action to be taken against a failure that is predicted.

4. The failure prediction apparatus according to claim 1,
wherein the acquisition unit acquires, as the external reaction information, a start date and time of reaction and an amount of change in reaction.

5. The failure prediction apparatus according to claim 2,
wherein the acquisition unit acquires, as the external reaction information, a start date and time of reaction and an amount of change in reaction.

6. The failure prediction apparatus according to claim 3,
wherein the acquisition unit acquires, as the external reaction information, a start date and time of reaction and an amount of change in reaction.

7. The failure prediction apparatus according to claim 4,
wherein the acquisition unit further acquires, as the external reaction information, a maximum amount of reaction and a period from start of reaction until the reaction reaches the maximum amount.

8. The failure prediction apparatus according to claim 5,
wherein the acquisition unit further acquires, as the external reaction information, a maximum amount of reaction and a period from start of reaction until the reaction reaches the maximum amount.

9. The failure prediction apparatus according to claim 6,
wherein the acquisition unit further acquires, as the external reaction information, a maximum amount of reaction and a period from start of reaction until the reaction reaches the maximum amount.

10. The failure prediction apparatus according to claim 7,
wherein the acquisition unit further acquires, as the external reaction information, a period from start of reaction until the reaction decreases to a certain amount or less.

11. The failure prediction apparatus according to claim 8,
wherein the acquisition unit further acquires, as the external reaction information, a period from start of reaction until the reaction decreases to a certain amount or less.

12. The failure prediction apparatus according to claim 9,
wherein the acquisition unit further acquires, as the external reaction information, a period from start of reaction until the reaction decreases to a certain amount or less.

13. A learning device comprising:
a learning data acquisition unit that acquires a set of information regarding a failure occurred in another company, information regarding an in-house failure occurred due to the occurrence of the failure in the other company, and external reaction information generated due to the failure as learning data; and
a processor,
wherein the processor is configured to, by running a program, perform machine learning on a learning model by using the learning data such that the learning model outputs prediction information regarding occurrence of an in-house failure when external reaction information is input to the learning model.

14. The learning device according to claim 13,
wherein the learning data includes, as the information regarding an in-house failure, a date and time of occurrence of the in-house failure and a content of the failure.

15. The learning device according to claim 13,
wherein the learning data includes, as the external reaction information, a start date and time of reaction and an amount of change in reaction.

16. The learning device according to claim 14,
wherein the learning data includes, as the external reaction information, a start date and time of reaction and an amount of change in reaction.

17. The learning device according to claim 15,
wherein the learning data further includes, as the external reaction information, a maximum amount of reaction and a period from start of reaction until the reaction reaches the maximum amount.

18. The learning device according to claim 16,
wherein the learning data further includes, as the external reaction information, a maximum amount of reaction and a period from start of reaction until the reaction reaches the maximum amount.

19. The learning device according to claim 17,
wherein the learning data further includes, as the external reaction information, a period from start of reaction until the reaction decreases to a certain amount or less.

20. The learning device according to claim 18,
wherein the learning data further includes, as the external reaction information, a period from start of reaction until the reaction decreases to a certain amount or less.
